(19) United States
(12) Patent Application Publication
(10) Pub. No.: US 2022/0196427 A1
(43) Pub. Date: Jun. 23, 2022

(54) Mobile Device and Vehicle

(71) Applicants: Hyundai Motor Company, Seoul (KR); Kia Corporation, Seoul (KR)

(72) Inventors: Jae Yul Woo, Seoul (KR); Soobin Kim, Seoul (KR); Seunghyun Woo, Seoul (KR); Rowoon An, Seoul (KR)

(21) Appl. No.: 17/490,298

(22) Filed: Sep. 30, 2021

(30) Foreign Application Priority Data
Dec. 22, 2020 (KR) 10-2020-0181111

(51) Int. Cl. G01C 21/36; G06T 11/00; G06K 9/00; H04W 4/024; G01C 21/34

(52) U.S. Cl. CPC G01C 21/365; G06T 11/00; G06K 9/00791; G06T 2200/24; G01C 21/3602; G01C 21/3407; H04W 4/024

(57) ABSTRACT

A mobile device includes an input device configured to receive a user input, a location receiver configured to receive location information, an image obtainer configured to obtain an image of surrounding environment, a controller configured to perform a navigation function based on destination information received by the input device and the current location information obtained by the location receiver, and perform an augmented reality (AR) function based on image information on the image obtained by the image obtainer upon a determination that the current location is adjacent to the destination based on the destination information and the current location information during execution of the navigation function, and a display device configured to display a navigation image in response to the navigation function or an AR image in response to the AR function based on a control command of the controller.

### CROSS-REFERENCE TO RELATED APPLICATIONS

This application claims the benefit of Korean Patent Application No. 10-2020-0181111, filed on Dec. 22, 2020 in the Korean Intellectual Property Office, which application is hereby incorporated herein by reference.

### TECHNICAL FIELD

The present disclosure relates to a mobile device and a vehicle.

### BACKGROUND

Generally, various types of mobile devices such as mobile communication terminals, smart phones, tablets, personal computers (PC), notebooks, personal digital assistants (PDA), wearable devices, and digital cameras are widely used, with the recent development of digital technologies.

Conventional mobile devices include various functions, such as a call function, a multimedia playback function (for example, a music playback, a video playback), an internet function, a navigation function, and an augmented reality (AR) function. Among various functions, research and development for the AR function has been increased.

AR is a technology that shows real objects (for example, real environments) by synthesizing virtual related information (for example, text, images, etc.). Unlike virtual reality (VR), which targets only virtual space and objects, AR provides a virtual related object on top of an object called real-world environments, resulting in providing additional information that is difficult to obtain with only real-world environments to a user.

However, as the number of real objects and related information of the real objects provided in AR increase, in other words, since a lot of information is overlapped without rules within a limited screen, AR functions provided by conventional mobile devices are difficult for a user to grasp related information.

Accordingly, user's needs for requiring intuition in using AR functions have increased.

### SUMMARY

The present disclosure relates to a mobile device and a vehicle. Particular embodiments relate to a mobile device and a vehicle having a function of guiding a path to a destination.

Therefore, an embodiment of the present disclosure provides a mobile device and a vehicle for guiding a road by interworking a navigation function and an AR function.

Another embodiment of the present disclosure provides a mobile device and a vehicle for highlighting and displaying an image related to a destination.

Additional embodiment of the disclosure will be set forth in part in the description which follows and, in part, will be obvious from the description, or may be learned by practice of the disclosure.

In accordance with an embodiment of the present disclosure, a mobile device includes an input device configured to receive a user input, a location receiver configured to receive location information on a current location, an image obtainer configured to obtain an image of surrounding environment, a controller configured to perform a navigation function based on destination information received by the input device and the current location information obtained by the location receiver, and perform an augmented reality (AR) function based on image information on the image obtained by the image obtainer when it is determined that the current location is adjacent to the destination based on the destination information and the current location information during the execution of the navigation function, and a display device configured to display a navigation image in response to the navigation function or an AR image in response to the AR function, according to control command of the controller.

The controller may be configured to obtain distance information from the current location to the destination based on the destination information and the current location information, and determine that the current location is adjacent to the destination when it is identified that a distance to the destination is less than or equal to a reference distance based on the obtained distance information and preset reference distance information.

The controller may be configured to obtain information on an arrival time to the destination based on the destination information, the current location information, and driving speed information, obtain a remaining time until arrival at the destination based on the obtained information on the arrival time, and determine that the current location is adjacent to the destination when it is identified that the obtained remaining time is less than or equal to a reference time.

The controller may be configured to, when it is determined that the current location is adjacent to the destination, control the display device to display a notification window.

The controller may be configured to, when it is determined that switch command has been received through the input device, control the display device to switch the navigation image displayed on the display to the AR image.

The controller may be configured to, when it is determined that switch command has been received through the input device, terminate the navigation function.

The controller may be configured to, when it is determined that rejection command has been received through the input device, maintain display of the navigation image displayed on the display device.

The controller may be configured to identify objects in the AR image, identify a destination object in response to the destination information among the identified objects, identify a display position of the destination object among display positions, and control the display device to display by overlapping a preset image on the identified position.

The preset image may include a highlight image or a polygonal mark image.

The controller may be configured to include an AR application to perform the AR function and a navigation application to perform the navigation function.

When execution command of the AR application and execution command of the navigation application are received by the input device, the AR application and the navigation application are interworked and executed.

The controller may be configured to, when the destination information is received during execution of the AR function, transmit the received destination information to the navigation application, obtain path information in response to the current location information and the destination information through the navigation application, transmit the path information obtained through the navigation application to the AR application, and periodically transmit the current location information to the AR application while the navigation function is being executed.

The controller may be configured to, when a plurality of paths are obtained through the navigation application, control the display device to display respective path information for the plurality of paths through the AR function by the AR application, and transmit selection information on any one of the plurality of paths to the navigation application.

In accordance with another embodiment of the present disclosure, a vehicle includes a vehicle terminal including an input device and a display, a location receiver configured to receive location information on a current location, an image obtainer configured to obtain an image of a road environment, and a communicator configured to perform communication between the vehicle terminal, the location receiver, and the image obtainer, wherein the vehicle terminal is configured to perform a navigation function based on destination information received by the input device and the current location information obtained by the location receiver, perform an augmented reality (AR) function based on image information on the image obtained by the image obtainer when it is determined that the current location is adjacent to the destination based on the destination information and the current location information during the execution of the navigation function, and display a navigation image in response to the navigation function or an AR image in response to the AR function through the display device.

The vehicle terminal may be configured to obtain distance information from the current location to the destination based on the destination information and the current location information, and determine that the current location is adjacent to the destination when it is identified that a distance to the destination is less than or equal to a reference distance based on the obtained distance information and preset reference distance information.

The vehicle terminal may be configured to obtain information on an arrival time to the destination based on the destination information, the current location information, and driving speed information, obtain a remaining time until arrival at the destination based on the obtained information on the arrival time, and determine that the current location is adjacent to the destination when it is identified the obtained remaining time is less than or equal to a reference time.

The vehicle terminal may be configured to, when it is determined that the current location is adjacent to the destination, control the display device to display a notification window.

The vehicle terminal may be configured to, when it is determined that a switch command has been received through the input device, control the display device to switch the navigation image displayed on the display device to the AR image and terminate the navigation function, and when it is determined that a rejection command has been received through the input device, maintain display of the navigation image displayed on the display device.

The vehicle terminal may be configured to identify objects in the AR image, identify a destination object in response to the destination information among the identified objects, identify a display position of the destination object among display positions, and control the display device to display by overlapping a preset image on the identified display position.

The preset image may include a highlight image or a polygonal mark image.

The vehicle terminal may be configured to include an AR application to perform the AR function and a navigation application to perform the navigation function, and when execution command of the AR application and execution command of the navigation application are received by the input device, the AR application and the navigation application are interworked and executed.

### BRIEF DESCRIPTION OF THE DRAWINGS

These and/or other embodiments of the disclosure will become apparent and more readily appreciated from the following description of exemplary embodiments, taken in conjunction with the accompanying drawings, in which:

FIG. 1 is a control configuration diagram of a mobile device according to an exemplary embodiment;

FIG. 2 is a diagram illustrating an image display of a display device of a mobile device according to an exemplary embodiment;

FIGS. 3A, 3B and 3C are diagrams illustrating an image display in an AR function of a mobile device according to an exemplary embodiment;

FIG. 4 is a diagram illustrating an image display of a notification window of a mobile device according to an exemplary embodiment;

FIG. 5 is a diagram illustrating switching between a navigation image and an AR image of a mobile device according to an exemplary embodiment;

FIGS. 6A and 6B are diagrams illustrating switching AR images of a mobile device according to an exemplary embodiment;

FIG. 7 is a control flowchart of a mobile device according to an exemplary embodiment; and

FIG. 8 is a control configuration diagram of a vehicle according to an exemplary embodiment.

### DETAILED DESCRIPTION OF ILLUSTRATIVE EMBODIMENTS

Reference will now be made in detail to the embodiments of the present disclosure, examples of which are illustrated in the accompanying drawings, wherein like reference numerals refer to like elements throughout. This specification does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘parts’, ‘modules’, ‘members’, ‘blocks’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the specification, and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, embodiments of the present disclosure will be described in detail with reference to the accompanying drawings.

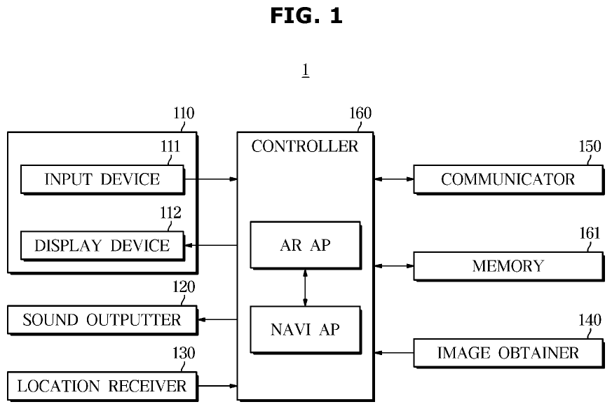

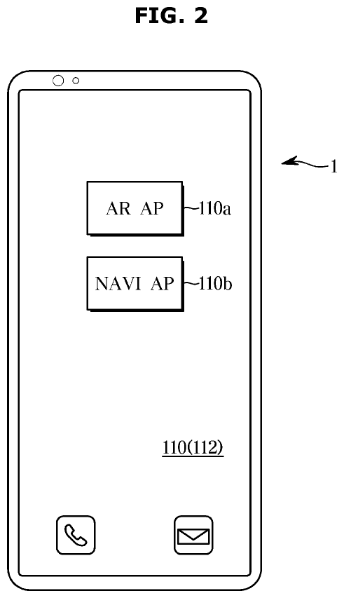

FIG. 1 is a control configuration diagram of a mobile device according to an exemplary embodiment, which will be described with reference to FIGS. 2 to 5 and FIGS. 6A and 6B.

The mobile device 1 may be implemented as a computer or a portable terminal that may be connected to a vehicle through a network.

Here, the computer includes, for example, a notebook equipped with a web browser, a desktop, a laptop, a tablet PC, a slate PC, and the like. The portable terminal includes, for example, as a wireless communication device that guarantees portability and mobility, all kinds of handheld-based wireless communication devices such as a personal communication system (PCS), global system for mobile communication (GMS), a personal digital cellular (PDA), an international mobile telecommunication-2000 (IMT-2000), a code division multiple access-2000 (CDMA-2000), a w-code division multiple access (W-CDMA), a wireless broadband internet (WiBro) terminal, a smart phone, and the like. In addition, the portable terminal also includes a wearable device such as a watch, a ring, a bracelet, a necklace, anklets, glasses, contact lenses, a head-mounted-device (HMD), and the like.

The mobile device 1 includes a user interface 110, a sound outputter 120, a location receiver 130, an image obtainer 140, a communicator 150, a controller 160, and a memory (i.e., a storage) 161.

The user interface 110 receives a user input and outputs a variety of information that the user may recognize. The user interface 110 may include an input device 111 and a display device 112.

The input device 111 receives the user input.

The input device 111 may receive a lock command, an unlock command, a power-on command, and a power-off command of the mobile device 1, and may receive an image display command of the display device.

The input device 111 may receive operation commands of various functions executable by the mobile device 1, and may receive setting values of various functions.

For example, the functions performed in the mobile device may include a call function, a text function, an audio function, a video function, a navigation function, a broadcast playback function, a radio function, a content playback function, and an internet search function, and also may include an execution function of at least one application installed in the mobile device.

The at least one application installed in the mobile device may be an application for providing at least one service to the user. Herein, a service may be to provide information for a user's safety, convenience, and fun.

The input device 111 may receive an execution command of a navigation application for performing the navigation function, and may receive an execution command of an AR application for performing an AR function.

The input device 111 may receive destination information in response to execution of the navigation function or execution of an autonomous driving function, and may receive path selection information for selecting one of a plurality of paths.

The input device 111 may receive destination information during execution of the AR function, and may receive path selection information for selecting one of the plurality of paths.

The input device 111 may receive point of interest (POI) information on the POI during execution of the AR function.

The input device 111 may receive a command to switch to the AR function or receive a rejection command while the navigation function is being executed.

The input device 111 may be implemented as a jog dial or a touch pad for inputting a cursor movement command and an icon or button selection command displayed on the display device 112.

The input device 111 may include a hardware device such as various buttons or switches, a pedal, a keyboard, a mouse, a track-ball, various levers, a handle, a stick, and the like.

Furthermore, the input device 111 may include a graphical user interface (GUI) such as a touch panel, in other words, a software device. The touch panel may be implemented as a touch screen panel (TSP) to form a layer structure with the display device 112.

The display device 112 may display execution information for at least one function performed by the mobile device 1 as an image, and may display information in response to a user input received in the input device 111 as an image.

The display device 112 may display an icon of an application for a function that may be performed on the mobile device 1. For example, the display device 112 may display an icon of the navigation application and an icon of the AR application.

The display device 112 may display map information and path guidance information while the navigation function is being executed, and may display current location information related to a current location. In other words, when the navigation function is executed, the display device 112 may display a navigation image in which a road guidance image in a map image and a current location image indicating a current location are matched.

The display device 112 displays at least one of a search window for searching for the POI, a path selection window for selecting any one of the plurality of paths to a destination, and an image display window for displaying an AR display image, in response to the user input during execution of the AR function.

The display device 112 may display information on switching to an AR image for the AR function as a notification pop-up window during execution of the navigation function.

The display device 112, when displaying the plurality of paths during execution of the AR function, may display current traffic conditions, an expected arrival time, and the like for each path.

The display device 112 may display information on at least one POI during execution of the AR function, and further display parking information, refueling information, and charging possibility information related to the POI.

When the POI is a store, the display device 112 may further display information on a store opening time, a price for each store menu, an average store price, whether to package, and whether to recharge during execution of the AR function.

The display device 112 may be provided as a cathode ray tube (CRT), a digital light processing (DLP) panel, a plasma display panel (PDP), a liquid crystal display (LCD) panel, an electro luminescence (EL) panel, an electrophoretic display (EPD) panel, an electrochromic display (ECD) panel, a light emitting diode (LED) panel or an organic light emitting diode (OLED) panel, and the like, but is not limited thereto.

Furthermore, the mobile device 1 may further include a sound receiver for receiving the user's voice. In this case, the controller 160 may perform a voice recognition function and may recognize the user input through the voice recognition function.

The sound receiver may include a microphone that converts sound waves into electrical signals. Herein, the number of microphones may be one or two or more, and at least one of the microphones may be directional.

Furthermore, the two or more microphones may be implemented as a microphone array.

The sound outputter 120 may output sound in response to a function being performed by the mobile device 1. The sound outputter 120 may include at least one or a plurality of speakers.

For example, the sound outputter 120 may output road guidance information as a sound while the navigation function is being performed.

The speaker converts an amplified low-frequency audio signal into an original sound wave, generates a longitudinal wave in the air, and copies a sound wave, resulting in outputting audio data as sound that the user may hear.

The location receiver 130 receives a signal for obtaining the current location information on the current location of the mobile device 1.

The location receiver 130 may be a Global Positioning System (GPS) receiver that communicates with a plurality of satellites. Herein, the GPS receiver includes an antenna module for receiving signals from the plurality of GPS satellites. Furthermore the GPS receiver includes software for obtaining the current location by using distance and time information in response to location signals of the plurality of the GPS satellites and an outputter for outputting the obtained location information of the vehicle.

The image obtainer 140 obtains an image of a vicinity of the mobile device 1, and transmits image information on the obtained image to the controller 160. Herein, the image information may be image data.

The image obtainer 140 is configured to obtain a front field of view of the mobile device 1 as a field of view.

The image obtainer 140 may include at least two or a plurality of cameras for obtaining an external image in a front-rear direction of the mobile device 1.

Assuming that a display surface of the mobile device is a front surface of the mobile device, at least one of the cameras may be disposed on the front surface of the mobile device, and the other camera may be disposed on a rear surface of the mobile device. Herein, the rear surface may be opposite to a front surface direction.

The image obtainer 140 is a camera, and may include a charge-coupled device (CCD) or a complementary metal oxide semiconductor (CMOS) image sensor and include a 3-dimensional (3D) spatial recognition sensor such as KINECT (RGB-D sensor), TOF (Structured Light Sensor), a stereo camera, etc.

The communicator 150 may receive at least one application from an external server, and may receive update information on the installed application.

The communicator 150 may include one or more components that enable communication between internal components of the mobile device 1, and may include, for example, at least one of a short-range communication module, a wired communication module, and a wireless communication module.

The short-range communication module may include various short-range communication modules that transmit and receive signals using the wireless communication network in a short-range, such as a Bluetooth module, an infrared communication module, a radio frequency identification (RFID) communication module, a wireless local access network (WLAN) communication module, a near field communication (NFC) module, a Zigbee communication module, or the like.

The wired communication module may include not only one of the various wired communication modules, such as a controller area network (CAN) communication module, a local area network (LAN) module, a wide area network (WAN) module, or a value added network (VAN) module, but also one of various cable communication modules, such as a universal serial bus (USB), a high definition multimedia interface (HDMI), a digital visual interface (DVI), recommended standard (RS) 232, a power cable, or a plain old telephone service (POTS), or the like.

The wired communication module may further include a local interconnect network (LIN) module.

The wireless communication module may include a wireless fidelity (WiFi) module, a wireless broadband (WiBro) module, and/or any wireless communication module for supporting various wireless communication schemes, such as a global system for a mobile communication (GSM) module, a code division multiple access (CDMA) module, a wideband code division multiple access (WCDMA) module, a universal mobile telecommunications system (UMTS), a time division multiple access (TDMA) module, a long-term evolution (LTE) module, etc.

The controller 160 controls an image display on the display device 112 based on at least one of the unlock command, the power-on command, and the image display command of the mobile device 1. In this case, as shown in FIG. 2, the display device 112 of the mobile device 1 may display icons for functions that may be performed in the mobile device 1 (e.g., AR AP 110a and NAVI AP 110b).

The controller 160, when the execution command of the AR application is received by the input device 111, may control display of an execution image of the AR function and may control the execution of the navigation application so that the navigation application is activated.

Furthermore, when the execution command of the AR application is received by the input device 111, the controller 160 may control an activation of the image obtainer 140, and control an activation of the location receiver 130 in response to the execution of the navigation application.

When the image obtainer 140 is activated, the controller 160 may perform image processing of an image obtained by the image obtainer and control display of the image-processed image. Furthermore, when the location receiver is activated, the controller 160 may obtain current location information of the mobile terminal based on the location information output from the location receiver 130.

When touch position information received by the input device 111 corresponds to a display position of the icon of the AR application, the controller 160 may determine that the execution command of the AR application has been received.

When a selection signal of an execution button of the AR application is received, the controller 160 may determine that the execution command of the AR application has been received. Herein, the execution button of the AR application may be a physical button.

When it is identified that a plurality of navigation applications are present in the mobile device, the controller may identify an interactive navigation application that may be interworked with the AR application. Furthermore, when it is identified that a non-interactive navigation application is present, the controller may change an icon of the non-interactive navigation application to display in an inactive state.

Herein, changing and displaying the icon of the non-interactive navigation application being in the inactive state may include processing the icon in a shaded state.

The controller 160 may perform interworking with a preset navigation application or a navigation application selected by the user while the AR function is being executed.

The controller 160 may transmit information about POI, destination information, current location information, and a plurality of path information stored in the navigation application to the AR application in interworking with the navigation function while the AR function is executed.

The controller 160 may display at least one of the search window for searching for the POI, the path selection window for selecting any one of the plurality of paths to the destination, and the image display window for displaying the AR display image, in response to the user input while the AR function is executed.

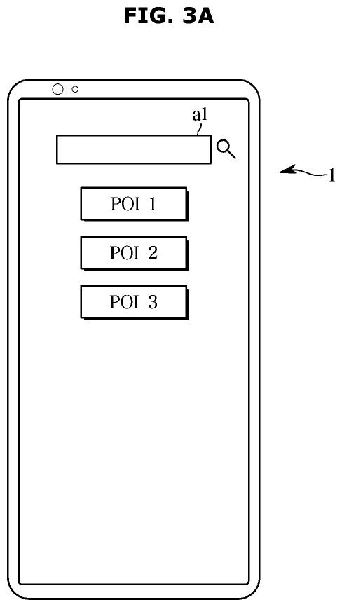

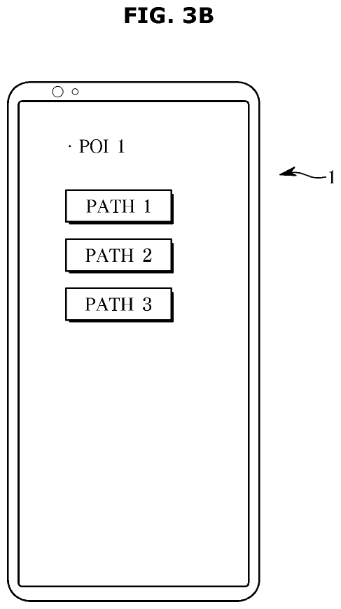

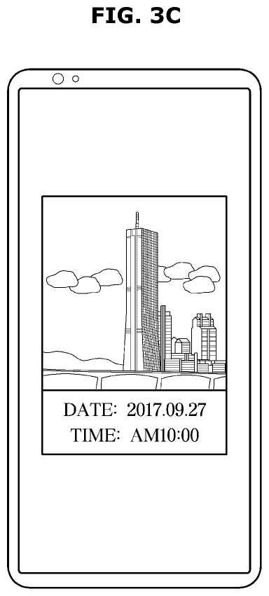

In this case, as shown in FIG. 3A, the display device 112 of the mobile device 1 may display the search window a1 for searching for the POI, and display information on previously searched or stored POIs as a button type.

The controller 160 may set information of the POI received through the input device 111 as destination information, search for a path from the current location to the destination based on the preset destination information and the current location information, and display information on the searched path.

When a plurality of paths are found, the controller 160 may control the display to display information on the plurality of paths. As shown in FIG. 3B, the display device 112 of the mobile device 1 may display the plurality of paths information to the POI as the button type.

The controller 160 may control the display device 112 to display detailed information on the plurality of paths information on one screen. Herein, the detailed information may include arrival time, moving distance, traffic information, and the like.

When any one of the plurality of paths is selected by the input device 111, the controller 160 may display the detailed information on the selected path.

The controller 160 may control the display device 112 to display the image obtained by the image obtainer and an image for additional information together through the image display window according to the display command of the AR image. As shown in FIG. 3C, the display device 112 of the mobile device may display the image obtained by the image obtainer 140 and the image for additional information in an overlapping manner. Herein, the additional information may include the destination information, the current location information, driving speed information, time information remaining to the destination, distance information remaining to the destination, and the like, and may further include traffic condition information.

The controller 160 may identify the destination information input by the input device and the current location information received by the location receiver during execution of the navigation function, search for a path from the current location to the destination based on the identified current location information and the identified destination information, obtain the path guidance information for the searched path, control the display device 112 to display the navigation image in which the current location information, destination information, and path information are matched on map information, and control at least one of the display device 112 and the sound outputter 120 to output road guidance information based on the current location information.

The controller 160 transmits the received destination information to the navigation application when the destination information is received in the AR application in a state of displaying the AR application while the navigation function and the AR function are interworking, and generates the path information through the navigation application and also may transmit the generated path information to the AR application.

The controller 160 may control at least one of the display device 112 and the sound outputter 120 so that, when a navigation command is received during interworking of the navigation function and the AR function, the road guidance information is output while displaying the navigation image.

When the navigation application is in a web format, the controller 160 may control the display device 112 to display the navigation image as an in-app pop-up on the application.

When the navigation application is not in the web format, the controller 160 may control the display device 112 to display the navigation image by performing redirection on the navigation application.

The controller 160 may control the display device 112 to display the navigation image during interworking of the navigation function and the AR function, and when it is determined that the current location is adjacent to the destination, switch the navigation image to the AR image to display.

The controller 160 determines whether the current location is adjacent to the destination based on the current location information and the destination information, and when it is determined that the current location is adjacent to the destination, the controller 160 may control the display device 112 to display the notification pop-up window suggesting a switch to the AR image.

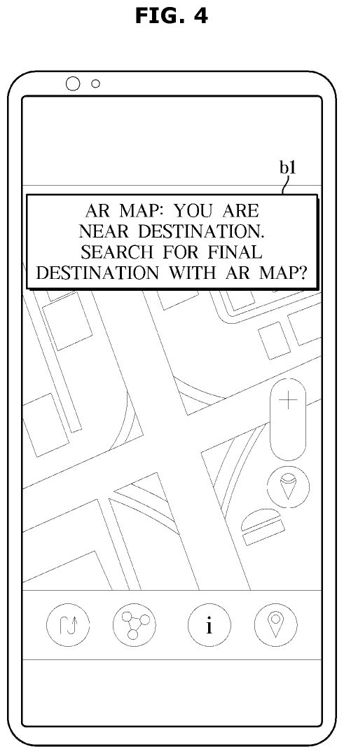

As shown in FIG. 4, the display device 112 of the mobile device may display the notification window b1 by overlapping the notification window on the navigation image.

When a switch command is received by the input device 111, the controller 160 controls the display device 112 to switch the navigation image to the AR image and display the AR image on the display device 112.

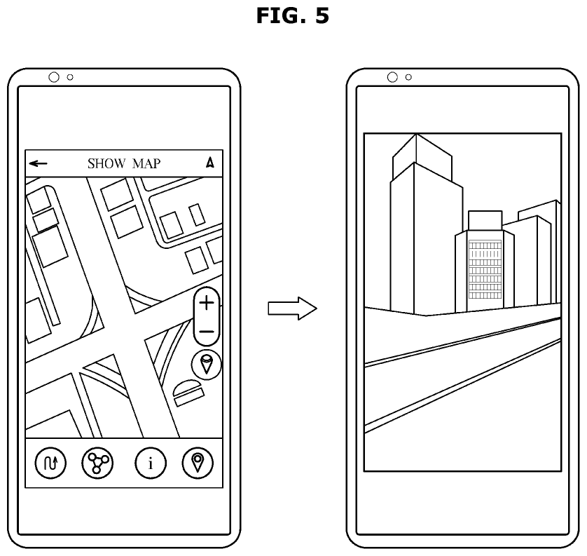

As shown in FIG. 5, the display device 112 of the mobile device may switch the navigation image to the AR image and display it. Herein, the AR image may include an image obtained through the image obtainer, and may further include the image for additional information.

When the rejection command is received by the input device 111, the controller 160 controls the display device 112 to maintain display of the navigation image.

The controller 160 may determine whether the switch command or the rejection command is received based on location information of a switch button of the notification window, location information of a rejection button, and location information of a touch point input to the input device.

In other words, when it is determined that the location information of the touch point input to the input device 111 is the same as the location information of the switch button of the notification window, the controller 160 may determine that the switch command has been received. And, when it is determined that the location information of the touch point input to the input device 111 is the same as the location information of the rejection button of the notification window, the controller 160 may determine that the rejection command has been received.

The controller 160 may transmit the current location information received by the location receiver 130 to the AR application while controlling display of the navigation image.

When the switch command is received, the controller 160 may control the display device 112 to switch and display the AR image, and then control termination of the navigation function.

When it is determined that the current location is adjacent to the destination, the controller 160 may activate the AR function to control the AR function to be linked with the navigation function.

The controller 160 may determine whether the current location is adjacent to the destination based on the expected arrival time to the destination and current time. In other words, the controller 160 obtains remaining time until arrival at the destination based on the expected arrival time to the destination and the current time, and when the obtained remaining time is less than or equal to a reference time, it may be determined that the current location is adjacent to the destination.

The controller 160 may obtain distance information between the current location and the destination based on the current location information and the destination information, and obtain the expected arrival time to the destination based on the obtained distance information and the driving speed.

Driving speed information may be obtained based on a distance change per second or a distance change per minute. Herein, the distance change may be obtained based on a change in the location information received by the location receiver.

The controller 160 obtains the distance information between the current location and the destination based on the current location information and the destination information, and when it is determined that the distance between the current location and the destination is less than or equal to a reference distance based on the obtained distance information and the reference distance information, may determine whether the current location is adjacent to the destination.

The controller 160 may control the display device 112 to overlap and display a preset image on a destination image in response to the destination information through interworking of the AR function and the navigation function. Herein, the preset image may be a highlight image for visually identifying the destination image and/or a polygonal mark image.

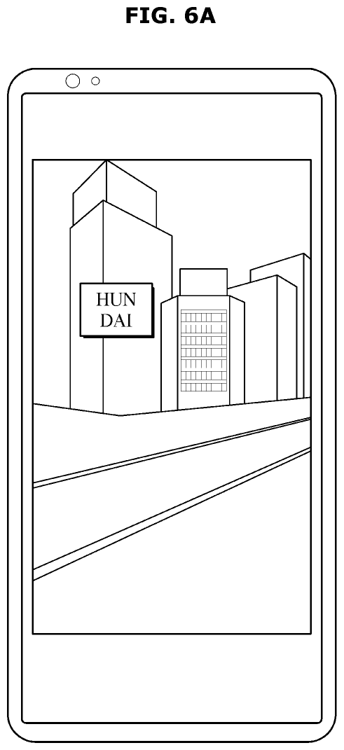

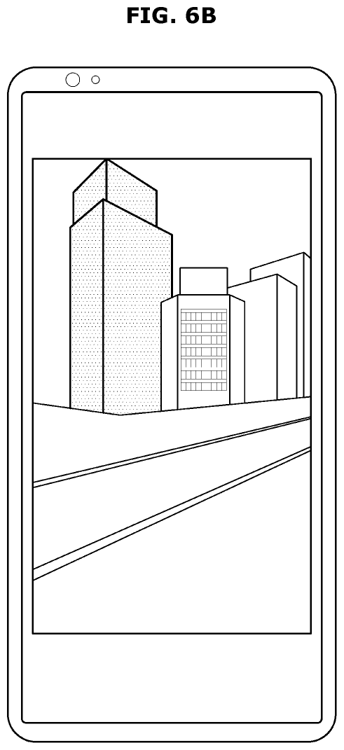

As shown in FIG. 6A, the display device 112 of the mobile device 1 displays the AR image, but may display by overlapping the mark image on the destination image in response to a destination object among the objects in the image obtained by the image obtainer.

The display device 112 of the mobile device 1 identifies objects in the AR image, identifies a destination object in response to the destination information among the identified objects, identifies a display position of the destination object among display positions, and displays by overlapping a preset image (e.g., the mark image) on the identified display position.

As shown in FIG. 6B, the display device 112 of the mobile device 1 displays the AR image, but may display by overlapping the highlight image on the destination image in response to the destination object among the objects in the image obtained by the image obtainer.

The controller 160, when it is determined that the current location is adjacent to the destination, identifies the destination object in response to the destination information among the objects in the external image based on the map information, the external image information, and the destination information, and displays the preset image overlaid on the image of the identified destination object.

The controller 160 may identify a region in which an image of the destination object is displayed among an overall region of the display device 112, and control the display device 112 to display the preset image in the identified region.

The controller 160, when it is determined that the current location is the destination, may control termination of the AR application.

The memory 161 stores the map information.

The memory 161 may store the location information on the POI. Herein, the location information on the POI may include a longitude value and a latitude value and may include address information.

The POI may be a point selected by the user.

The memory 161 may be implemented as at least one of a non-volatile memory device such as a cache, a read only memory (ROM), a programmable ROM (PROM), an erasable programmable ROM (EPROM), an electrically erasable programmable ROM (EEPROM), and flash memory or a volatile memory device such as a random access memory (RAM) or a storage medium such as a hard disk drive (HDD), or a compact disc ROM, but is not limited thereto. The memory 161 may be a memory implemented as a chip separate from the processor described above with respect to the controller, or may be implemented as a single chip with the processor.

At least one component may be added or deleted according to performance of the components of the mobile device 1 shown in FIG. 1. Furthermore, it will be readily understood by those of ordinary skill in the art that mutual positions of the components may be changed corresponding to performance or structure of the system.

Meanwhile, each component shown in FIG. 1 may refer to software and/or hardware components, such as a field programmable gate array (FPGA) and an application specific integrated circuit (ASIC).

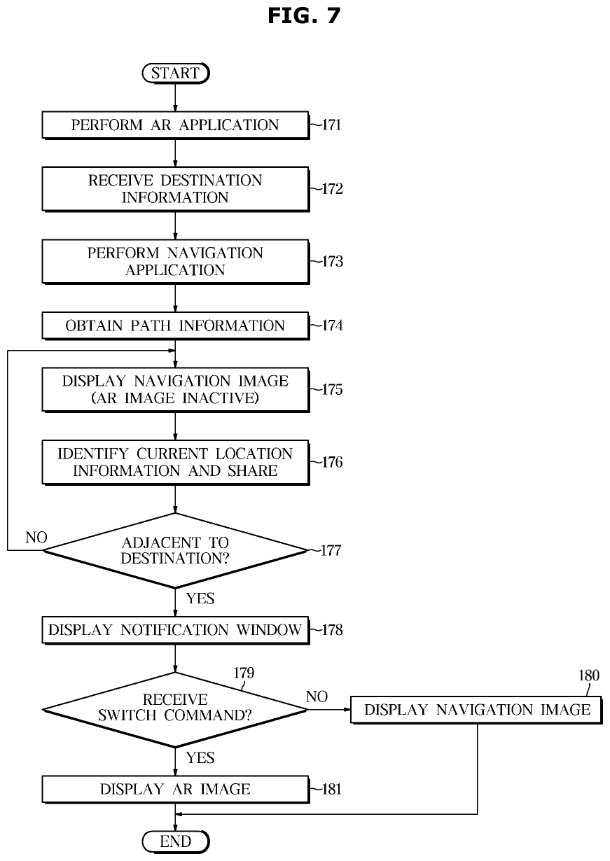

FIG. 7 is a control flowchart of the mobile device according to an exemplary embodiment.

When at least one of the unlock command, the power-on command, and the image display command is received through the input device 111, the mobile device 1 displays a basic image on the display device 112. In other words, the mobile device 1 may switch the image display of the display device 112 from an inactive state to an active state. Herein, the basic image may be an image of a screen, an image predetermined by the user, or an image in which icons of applications executable on the mobile device 1 are displayed.

When the execution command of the AR application is received by the input device 111, the mobile device 1 may perform the AR function through the execution of the AR application (171). At this time, the mobile device 1 may display the execution image of the AR function.

When the destination information is received by the input device 111 in a state in which the AR function is performed (172), the mobile device may execute the navigation application (173) and transmit the destination information to the navigation application.

When the execution command of the AR application is received by the input device 111, the mobile device may control the activation of the image obtainer 140, and may control the activation of the location receiver 130 in response to the execution of the navigation application.

The mobile device 1 may obtain the current location information of the mobile device based on the location information received from the location receiver and transmit the obtained current location information to the navigation application.

The mobile device 1 may search for a path from the current location to the destination based on the current location information and the destination information through the execution of the navigation application, and transmit the path information on the found path to the AR application.

Furthermore, when the plurality of paths are found, the mobile device 1 may transmit the path information on the plurality of paths to the AR application.

The mobile device 1 may display the path information for one or the plurality of paths through the AR application.

The mobile device 1 may display detailed information for the plurality of paths information on one screen through the AR application. Herein, the detailed information may include arrival time, moving distance, traffic information, and the like.

The mobile device 1 may display the detailed information on any one path selected by the user among the plurality of paths through the AR application.

When the navigation command is received, the mobile device 1 obtains the path information on the path selected by the user or a path recommended by the mobile device (174), and displays the navigation image in which the obtained path information and the path guidance information match the map information (175). At this time, the AR image may be in inactive state, resulting in not displaying through the mobile device 1.

Furthermore, the mobile device 1 may display the navigation image in a section of the display in response to a region division command of the display, and display the AR image in another section.

The mobile device periodically identifies the current location information while displaying the navigation image during the navigation function is being executed.

The mobile device may transmit the identified current location information to the AR application. In other words, the mobile device shares the current location information between the navigation application and the AR application (176). Through this, it is also possible to determine whether the current location is adjacent to the destination based on the destination information and the current location information on the AR application.

The mobile device determines whether the current location is adjacent to the destination based on the current location information and the destination information while performing the navigation function (177), and when it is determined that the current location is adjacent to the destination, the notification pop-up windows suggesting switching to the AR image is displayed (178).

Determining whether the current location is adjacent to the destination may include obtaining the distance information between the current location and the destination based on the current location information and the destination information, and determining that the current location is adjacent to the destination when it is identified that the distance between the current location and the destination is less than or equal to the reference distance based on the obtained distance information and the reference distance information.

The mobile device 1 may determine whether the current location is adjacent to the destination based on the expected arrival time to the destination and the current time. In other words, the mobile device 1 may obtain the remaining time until arrival at the destination based on the expected arrival time to the destination and the current time, and when the obtained remaining time is less than or equal to the reference time, it may be determined that the current location is adjacent to the destination.

The mobile device 1 determines whether the switch command has been received by the input device 111 (179), and when it is determined that the switch command is not received within a preset time, continuously displays the navigation image (180).

When it is determined that the rejection command is received by the input device 111, the mobile device may continuously display the navigation image 180.

When it is determined that the switch command has been received by the input device 111 (179), the mobile device may switch the navigation image to the AR image. In other words, the mobile device may display the AR image (181).

Herein, the AR image may include the image obtained through the image obtainer, and may further include the image related to the additional information.

For example, the mobile device 1 may display the AR image, but display by overlapping the mark image on the destination image in response to the destination object among the objects in the image obtained by the image obtainer.

The mobile device 1 may display the AR image, but display by overlapping the highlight image on the destination image in response to the destination object among the objects in the image obtained by the image obtainer.

The mobile device 1 may control the termination of the navigation application when the switch command is received.

The mobile device 1, when it is determined that the current location is the destination, may control the termination of the AR application.

The mobile device, when it is determined that the current location is the destination, may control the termination of the navigation application and the AR application.

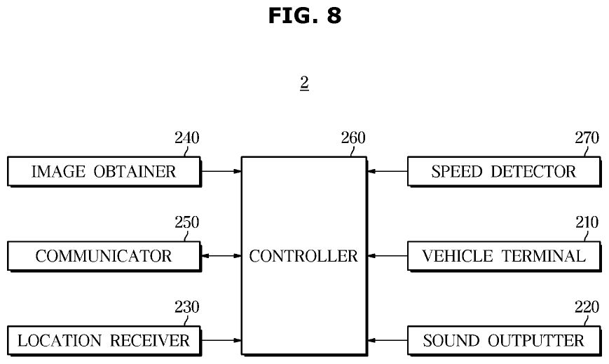

FIG. 8 is a control configuration diagram of a vehicle according to an exemplary embodiment.

First, the vehicle 2 includes a vehicle body having an exterior and an interior and a chassis configured to occupy the remaining portions except for the vehicle body to have mechanical devices required for driving installed thereon.

The chassis of the vehicle is a frame that supports the vehicle body, and includes a plurality of wheels, a powertrain for applying a driving force to the plurality of wheels, a steering device, a braking device for applying a braking force to the plurality of wheels, and a suspension device for adjusting a vehicle's suspension.

The exterior of the vehicle body may include a front panel, a bonnet, a roof panel, a rear panel, front-left, front-right, rear-left, and rear-right doors, and a window configured at each of the front-left, front-right, rear-left, and rear-right doors to be opened and closed.

Furthermore, the exterior of the vehicle body further include an antenna that receives signals from GPS satellites and broadcasting stations and performs a wireless vehicle networks such as a vehicle-to-everything (V2X), a vehicle to vehicle (V2V), and a vehicle-to-infrastructure (V2I), etc.

The interior of the vehicle body includes a seat for occupants, a dashboard, an instrument panel (or cluster), which is disposed on the dash board, including a tachometer, a speedometer, a coolant thermometer, a fuel gauge, a turn indicator, a high beam indicator, a warning lamp, a seat belt warning lamp, an odometer, a shift lever indicator light, a door open warning light, an engine oil warning light, and a low fuel warning light, a center fascia in which an air vent and a throttle of an air conditioner are disposed, and a head unit which is provided on the center fascia and receives operation commands of an audio device and the air conditioner.

The vehicle includes a vehicle terminal 210 for user convenience. The vehicle terminal 210 may be installed on the dashboard in an embedded or mounted manner.

The vehicle terminal 210 may receive a user input and display information on various functions performed in the vehicle as images.

Herein, the various functions may include functions of at least one application installed by the user among the audio function, the video function, the navigation function, the broadcasting function, the radio function, the content playback function, and the Internet function.

The vehicle terminal may include a display panel as the display and may further include a touch panel as the input device. Such a vehicle terminal may include only the display panel, or may include a touch screen in which the touch panel is integrated with the display panel.

When the vehicle terminal 210 is implemented with only the display panel, a button displayed on the display panel may be selected using the input device (not shown) provided on the center fascia.

The vehicle terminal 210 may include an input device and a display. The input device and the display of the vehicle are the same as the input device and the display of the mobile device, so a description thereof will be omitted.

The vehicle terminal 210 may perform various control functions performed by the controller of the mobile terminal according to an exemplary embodiment. Control of the navigation function and the AR function performed in the vehicle terminal 210 is the same as the control configurations for the function performed by the controller of the mobile terminal according to the exemplary embodiment, and thus a description thereof will be omitted.

The vehicle terminal 210 may further include a memory for storing map information and location information of the POI.

A sound outputter 220 outputs audio data in response to a function being performed in the vehicle as sound.

The function being performed here may be a radio function, an audio function in response to a content playback and a music playback, and a navigation function.

The sound outputter 220 may include a speaker. The sound outputter 220 may include at least one or a plurality of speakers.

Furthermore, the speakers may be provided in the vehicle terminal 210.

A location receiver 230 includes a GPS receiver and a signal processor for processing the GPS signal obtained from the GPS receiver.

The vehicle 2 may further include an image obtainer 240 for obtaining an image of surroundings. Herein, the image obtainer 240 may be an image obtainer provided in a black box, an image obtainer of an autonomous driving control device for autonomous driving, or an image obtainer for detecting an obstacle.

The image obtainer 240 may be provided on a front window, but may be provided on a window inside the vehicle, a rear view mirror in the interior of the vehicle, or a roof panel but exposed to the outside.

The image obtainer 240 may further include at least one of a front camera for obtaining an image of the front of the vehicle, a left camera and a right camera for obtaining images of left and right sides of the vehicle, and a rear camera for obtaining an image of the rear of the vehicle.

The image obtainer 240 is a camera, and may include a CCD or a CMOS image sensor and include a 3D spatial recognition sensor such as KINECT (RGB-D sensor), TOF (Structured Light Sensor), a stereo camera, etc.

The vehicle 2 may further include a communicator 250 for communication between various internal electronic devices, communication with a user terminal, and communication with a server.

The communicator 250 may communicate with an external device through an antenna.

Herein, the external device may include at least one of the server, the user terminal, other vehicles, and infrastructures.

Furthermore, communication methods using the antenna may include a second generation (2G) communication method such as a TDMA and a CDMA, a third generation (3G) communication method such as a WCDMA, a CDMA, a WiBro, a world interoperability for microwave access (WiMAX), a fourth generation (4G) communication method such as a LTE, a wireless broadband evolution (WBE), and a fifth generation (5G) communication method.

The controller 260 controls communication between the vehicle terminal 210 and the image obtainer 240, the location receiver 230, and the sound outputter 220.

The controller 260 may transmit image information of the image obtainer 240 to the vehicle terminal 210, transmit location information of the location receiver 230 to the vehicle terminal 210, and transmit sound information of the vehicle terminal 210 to the sound outputter 220.

The vehicle may further include a speed detector 270 for obtaining a traveling speed (i.e., a driving speed of the vehicle).

The speed detector 270 may be a wheel speed sensor provided on each of the plurality of wheels, or may be an acceleration sensor.

The controller 260 may obtain the traveling speed of the vehicle based on at least one of wheel speed detected by the plurality of wheel speed sensors, and acceleration detected by the acceleration sensor.

Furthermore, the controller 260 may transmit the acquired traveling speed to the vehicle terminal so as to obtain the expected arrival time to the destination or the remaining time until arrival at the destination.

At least one component may be added or deleted according to performance of the components of the vehicle shown in FIG. 8. Furthermore, it will be readily understood by those of ordinary skill in the art that mutual positions of the components may be changed corresponding to performance or structure of the system.

Meanwhile, each component shown in FIG. 8 may refer to software and/or hardware components, such as a FPGA and an ASIC.

As is apparent from the above description, the embodiments of the present disclosure can perform complementary and seamless path guidance by switching the navigation function and the AR function or interworking the navigation function and the AR function to guide a way to the destination, so that the user can conveniently move to the destination.

Embodiments of the present disclosure can further facilitate the user's recognition of the destination by providing the user with the image of the destination when guiding the way to the destination, thereby maximizing the user's convenience and maintaining a utility of commercial services.

Embodiments of the present disclosure, since the AR function is performed only when necessary information is provided, can further prevent a decrease in execution speed of the navigation function.

In the case of a development company that develops AR applications, it is possible to quickly launch an AR navigation service, which is an innovative technology, to the market by first building a POI that users are interested in instead of building all regions when creating essential point cloud maps and building systems so as to utilize Visual SLAM technology, which is the core of AR.

In the case of a development company that develops navigation applications, it is possible to decrease a burden of adding AR services that require a lot of technical proficiency or complicated calculations in a processing process to the navigation function.

Embodiments of the present disclosure enable a development company that develops AR applications or a development company that develops navigation applications to be faithful to an original technology development.

As described above, embodiments of the present disclosure can improve quality and merchantability of mobile devices and vehicles, further increase user satisfaction, improve user convenience, reliability, and vehicle safety, and secure product competitiveness.

Meanwhile, the embodiments of the present disclosure may be implemented in the form of recording media for storing instructions to be carried out by a computer. The instructions may be stored in the form of program codes, and when executed by a processor, may generate program modules to perform an operation in the embodiments of the present disclosure. The recording media may correspond to computer-readable recording media.

The computer-readable recording medium includes any type of recording medium having data stored thereon that may be thereafter read by a computer. For example, it may be a Read Only Memory (ROM), a Random Access Memory (RAM), a magnetic tape, a magnetic disk, a flash memory, an optical data storage device, and the like.

What is claimed is:

1. A mobile device comprising:
an input device configured to receive a user input;
a location receiver configured to receive location information on a current location of the mobile device;
an image obtainer configured to obtain an image of surrounding environment;
a controller configured to:
perform a navigation function based on destination information received by the input device and the current location information obtained by the location receiver; and
perform an augmented reality (AR) function based on image information on the image obtained by the image obtainer upon a determination that the current location is adjacent to the destination based on the destination information and the current location information during execution of the navigation function; and
a display device configured to display a navigation image in response to the navigation function or an AR image in response to the AR function based on a control command of the controller.

2. The mobile device of claim 1, wherein the controller is configured to:
obtain distance information from the current location to the destination based on the destination information and the current location information; and
determine that the current location is adjacent to the destination when it is identified that a distance to the destination is less than or equal to a reference distance based on the obtained distance information and preset reference distance information.

3. The mobile device of claim 1, wherein the controller is configured to:
obtain information on a arrival time to the destination based on the destination information, the current location information, and driving speed information;
obtain a remaining time until arrival at the destination based on the obtained information on the arrival time; and
determine that the current location is adjacent to the destination when it is identified that the obtained remaining time is less than or equal to a reference time.

4. The mobile device of claim 1, wherein the controller is configured to control the display device to display a notification window upon a determination that the current location is adjacent to the destination.

5. The mobile device of claim 4, wherein the controller is configured to control the display device to switch the navigation image displayed on the display device to the AR image upon a determination that a switch command has been received through the input device.

6. The mobile device of claim 5, wherein the controller is configured to terminate the navigation function upon the determination that the switch command has been received through the input device.

7. The mobile device of claim 4, wherein the controller is configured to maintain display of the navigation image displayed on the display device upon a determination that a rejection command has been received through the input device.

8. The mobile device of claim 1, wherein the controller is configured to:
identify objects in the AR image;
identify a destination object in response to the destination information among the identified objects;
identify a display position of the destination object among display positions; and
control the display device to display by overlapping a preset image on the identified display position.

9. The mobile device of claim 8, wherein the preset image includes a highlight image or a polygonal mark image.

10. The mobile device of claim 1, wherein:
the controller is configured to include an AR application to perform the AR function and a navigation application to perform the navigation function; and
the AR application and the navigation application are configured to be interworked and executed upon receipt of an execution command of the AR application and an execution command of the navigation application by the input device.

11. The mobile device of claim 10, wherein the controller is configured to:
transmit the received destination information to the navigation application upon receipt of the destination information during execution of the AR function;
obtain path information in response to the current location information and the destination information through the navigation application;
transmit the path information obtained through the navigation application to the AR application; and
periodically transmit the current location information to the AR application while the navigation function is being executed.

12. The mobile device of claim 11, wherein the controller is configured to:
control the display device to display respective path information for a plurality of paths through the AR function by the AR application when the plurality of paths are obtained through the navigation application; and
transmit selection information on any one of the plurality of paths to the navigation application.

13. A vehicle comprising:
a vehicle terminal including an input device and a display;
a location receiver configured to receive location information on a current location of the vehicle;
an image obtainer configured to obtain an image of a road environment; and
a communicator configured to perform communication between the vehicle terminal, the location receiver, and the image obtainer;
wherein the vehicle terminal is configured to:
perform a navigation function based on destination information received by the input device and the current location information obtained by the location receiver;
perform an augmented reality (AR) function based on image information on the image obtained by the image obtainer upon a determination that the current location is adjacent to the destination based on the destination information and the current location information during execution of the navigation function; and
display a navigation image in response to the navigation function or an AR image in response to the AR function through the display device.

14. The vehicle of claim 13, wherein the vehicle terminal is configured to:
obtain distance information from the current location to the destination based on the destination information and the current location information; and
determine that the current location is adjacent to the destination upon determination that a distance to the destination is less than or equal to a reference distance based on the obtained distance information and preset reference distance information.

15. The vehicle of claim 13, wherein the vehicle terminal is configured to:
obtain information on a arrival time to the destination based on the destination information, the current location information, and driving speed information;
obtain a remaining time until arrival at the destination based on the obtained information on the arrival time; and
determine that the current location is adjacent to the destination upon a determination that the obtained remaining time is less than or equal to a reference time.

16. The vehicle of claim 13, wherein the vehicle terminal is configured to control the display device to display a notification window upon a determination that the current location is adjacent to the destination.

17. The vehicle of claim 16, wherein the vehicle terminal is configured to:
control the display device to switch the navigation image displayed on the display device to the AR image and terminate the navigation function upon a determination that a switch command has been received through the input device; and
maintain display of the navigation image displayed on the display device upon a determination that a rejection command has been received through the input device.

18. The vehicle of claim 13, wherein the vehicle terminal is configured to:
identify objects in the AR image;
identify a destination object in response to the destination information among the identified objects;
identify a display position of the destination object among display positions; and
control the display device to display by overlapping a preset image on the identified position.

19. The vehicle of claim 18, wherein the preset image includes a highlight image or a polygonal mark image.

20. The vehicle of claim 18, wherein:
the vehicle terminal is configured to include an AR application to perform the AR function and a navigation application to perform the navigation function; and
the AR application and the navigation application are configured to be interworked and executed upon receipt of an execution command of the AR application and an execution command of the navigation application.
